(19) United States
(12) Patent Application Publication
(10) Pub. No.: US 2026/0300945 A1
(43) Pub. Date: Oct. 1, 2026

(54) INTERCONNECTED EXCHANGE OF PAYMENT INFORMATION FOR VALUE TRANSACTIONS SETTLED ON DISTRIBUTED LEDGER NETWORKS

(71) Applicant: SAP SE, Walldorf (DE)

(72) Inventors: Stefan Arnold, Leimen (DE); Bernhard Schweizer, Nussloch (DE); Brit Panzer, Mannheim (DE)

(21) Appl. No.: 19/377,779

(22) Filed: Nov. 3, 2025

Related U.S. Application Data
(60) Provisional application No. 63/781,700, filed on Apr. 1, 2025.

(51) Int. Cl. G06Q 20/10; G06Q 20/38

(52) U.S. Cl. CPC G06Q 20/10; G06Q 20/3821; G06Q 20/3829; G06Q 20/389; G06Q 2220/00

(57) ABSTRACT

The present disclosure relates to computer-implemented methods, software, and systems for persisting remittance information associated with transactions executed at a decentralized ledger. Transaction information for a first transaction executed by a payer at the decentralized ledger can be obtained by a payee system. The transaction information is associated with a transfer of digital assets from a payer account to a payee account of a payee. The transaction information comprises an identifier associated with the first transaction. Based on the identifier associated with the first transaction, remittance information associated with the first transaction can be obtained from the decentralized ledger or through a remittance storage service. The remittance information can be provided to the payee account of the payee as part of providing the transfer of the digital assets to the payee.

### CLAIM OF PRIORITY

This application claims priority under 35 USC § 119 (e) to U.S. Provisional Application Ser. No. 63/781,700, filed on Apr. 1, 2025, entitled “INTERCONNECTED EXCHANGE OF PAYMENT INFORMATION FOR VALUE TRANSACTIONS SETTLED ON DISTRIBUTED LEDGER NETWORKS” (Attorney Docket No. 22135-1943P01/250202US01); the entire contents of which are hereby incorporated by reference.

### BACKGROUND

Enterprises interact at various levels in cooperative efforts. For example, enterprises can engage with each other and transactions between enterprises can occur using or otherwise recorded within one or more digital records. Management of digital records can be performed manually and can be a resource-intensive task that inherently provides insecurity during data exchange and negotiation. For example, data sharing during tracking and tracing materials in a cross-company supply chain provides value in many business scenarios and may require data verification and communication between systems associated with different technology and requirements.

### SUMMARY

Implementations of the present disclosure are directed to computer-implemented methods for persisting remittance information associated with transactions executed at a decentralized ledger to be provided as part of a payment process flow.

One example method may include operations such as: obtaining transaction information for a first transaction executed by a payer at a decentralized ledger to transfer of digital assets from a payer account to a payee account of a payee, wherein the transaction information comprises an identifier associated with the first transaction; obtaining, based on the identifier associated with the first transaction, remittance information associated with the first transaction; and providing the remittance information to the payee account of the payee as part of providing a transfer of the digital assets to the payee.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example conceptual architecture in accordance with implementations of the present disclosure where transaction information is persisted in a blockchain network and remittance information is maintained associated with the transaction information to be provided to the payee.

FIG. 3 depicts an example computer architecture in accordance with implementations of the present disclosure where a payment process between a payer and a payee is facilitated by an intermediary, and remittance information to the transaction is maintained at a blockchain network.

FIG. 4 depicts an example blockchain optimized format for storing remittance information at a blockchain.

FIG. 5 depicts an example flow for persisting remittance information during payment execution in accordance with implementations of the present disclosure.

FIG. 6 depicts an example conceptual architecture where remittance information is persisted at a central database service in accordance with implementations of the present disclosure.

FIG. 7 depicts an example computer environment including systems such as payer system, payee system, a payment information service, and a blockchain.

FIG. 8 is a schematic illustration of example computer systems that can be used to execute implementations of the present disclosure.

Additional figures and examples are depicted in the attached Appendix.

### DETAILED DESCRIPTION

In instances, business transactions can include fund transfers and interaction between multiple entities and/or computer systems. A transfer of funds that provides information only about their value is often insufficient for meaningful processing of the transaction in a business context. For example, in corporate finance, a received payment that lacks accompanying information, such as remittance data, settlement instructions, or other business context data, may be essentially unusable. In some cases, without this information, the recipient cannot accurately determine the purpose of the funds, reconcile them against open receivables, or comply with internal accounting and regulatory requirements in an efficient and secure manner. For example, a supplier receiving a digital payment without an associated invoice number or customer reference cannot match the funds to the correct transaction in their ERP system. This leads to delays, manual exception handling, potential compliance issues, and an overall breakdown in the automation and reliability of financial operations. Thus, payment information is not optional—it is integral to the business transaction. The value of the payment is important to be linked to the correct business context. Without this linkage, the payment remains without context and may not be possible to be connected to executed processes, and be connected to other data relevant for the receiving organization.

Moreover, in the context of complex multinational, cross-border, cross-currency, and/or cross legislation revenue chains, buyers and suppliers often interact with software systems and services to request execution of transactions, perform payments, and/or settle agreements. In those cases, the technological tools to facilitate the interactions between buyers and suppliers may need to be aligned with the preferences of the parties. Such alignment may be associated with technological challenges for the user systems and the exchange of different types of data or assets. For example, buyers may wish to pay using modern cryptocurrency or stablecoin methods, while suppliers may insist on traditional banking methods, or vice versa. In some cases, there may be cases where there would not even be an agreement on the underlying fiat currency to be used for settlement. In some instances, such incompatible payment terms create inefficiencies and friction in business relationships, as neither party is willing or able to directly accommodate the other's preferred terms.

A Fiat currency is a government-issued currency that serves as the legal tender, standard medium of exchange for goods and services. Their value is established by the trust in the issuing government and the stability of the economy, rather than being tied to a physical commodity like gold or silver. Central banks regulate them by managing supply, interest rates, and implementing economic policies to ensure stability and control inflation.

A Cryptocurrency is a digital currency that uses cryptography for security and operates on a technology called blockchain, which is a decentralized ledger. It is not controlled by any central authority like a government or bank, making it resistant to censorship and external control. Examples include Bitcoin, Ethereum, and many others.

A Stablecoin is a specific type of cryptocurrency designed to maintain a stable value by pegging it to a reserve of assets, such as a fiat currency (e.g., the US dollar and the European euro). This stability makes stablecoins more suitable for everyday transactions and as a store of value compared to highly volatile cryptocurrencies (e.g., Bitcoin or Ether).

A Smart Contract is an application that runs on a blockchain. It executes actions either automatically when predefined conditions are met or when triggered by any authorized participant, without the need for intermediaries. Smart contracts ensure transparency, security, and efficiency, as their rules and coding are immutable and verifiable on the blockchain. They can be used for various use cases, including financial transactions, digital identity management, and trustless information exchange.

Distributed ledger technology (DLT) can support the execution of transactions related to transforming payment, clearing, and settlement processes, including how funds and/or assets can be transferred and cleared. DLT can support the transfer and record of the ownership of digital assets, immutably and securely store information, and can provide for identity management. Distributed ledger technologies provide a shared truth for all participants represented by partner systems of the blockchain network.

Distributed ledger technologies can be categorized in terms of their data structures, consensus algorithms, permissions, etc. Blockchains are the most common DLT type, with a 256-bit secure hash algorithm (SHA). In some cases, distributed ledger systems (DLSs), which can also be referred to as consensus networks, and/or blockchain networks, enable participating entities to securely and immutably store data. DLSs are commonly referred to as blockchain networks without referencing any particular use case. Examples of types of blockchain networks can include public blockchain networks, private blockchain networks, and consortium blockchain networks. A consortium blockchain network can be provided for a select group of entities, which control the consensus process, and includes an access control layer. A blockchain is made up of a chain of blocks, each block storing data. Example data includes data representative of a data object created in relation to interactions between two or more participants. While data objects are used herein by way of non-limiting example, it is contemplated that any appropriate data can be stored in a blockchain (e.g., documents, images, videos, audio). The stored data in a blockchain may be hash values for documents, images, videos, audios, or other data objects in general. The stored data represents data that is immutably stored within the blockchain. That is, the stored data cannot be changed. Accordingly, a blockchain is a data structure that stores data in a way that the data is immutable and can be verified. Each block in the chain is linked to a previous block immediately before it in the chain by including a cryptographic hash of the previous block. A block also includes a timestamp, its own cryptographic hash, and data. Each block is provided based on one or more executed transactions.

In some instances, when a buyer and a supplier interact, they can execute a direct interaction between their respective systems or use an intermediary to facilitate the communication. Existing intermediary solutions typically focus on specific aspects such as payment execution, foreign exchange, or providing remittance information. However, there is no currently available holistic, interdisciplinary solution that consistently supports decentralized ledger technologies while addressing advanced corporate requirements, such as payment reconciliation of batched payments or netting of payables against open receivables. This lack of an enterprise-grade solution significantly hampers the adoption of stablecoins, as it creates a major barrier to convincing business partners to use them. Without an easy but still compliant way to integrate stablecoins directly or indirectly into existing financial processes, companies struggle to build the necessary network for their own usage.

A solution is needed that facilitates seamless intermediation between the buyer and supplier systems that supports interaction and transaction execution even if there are incompatibilities in the payment preferences as initially defined by the parties. In accordance with implementations of the present disclosure, a solution is provided that ensures reliable routing of executed payments to their ultimate beneficiaries alongside accurate reconciliation against open positions. In some instances, with the provided solution, an efficient mechanism for converting currencies, regardless of whether it involves cryptocurrency to fiat, fiat to cryptocurrency, cryptocurrency to cryptocurrency, or stablecoin to stablecoin is provided, while compliance, transparency, and security are also maintained. In accordance with the present implementations, a system is provided that utilize distributed ledger technologies, such as blockchains, to create a tamper-proof record of payment settlements and remittance information that support a trustless operating model for transaction parties. The systems of participants associated with a transaction can be configured to adhere to a common protocol (e.g., pre-agreed for the systems or set up per default, among other examples). Here all participants adhering to the same underlying protocol they agreed-upon, which can easily connect and transact via interoperable processes.

In some implementations, a solution can be provided to support efficient transaction execution between a payer system and a payee system that is performed based on relying on DLT to store data for the transaction (e.g., amount or assets being exchanged) as well as remittance information for the transaction (e.g., reference of a payment, invoice number, billing code, etc.). In some instances, the transactions can be executed with or without the support of an intermediary, where the use of an intermediary would not change the solution, and the operations performed by the intermediary can be distributed between the payer and/or payee system. In some cases, if an intermediary can be used, the intermediary can facilitate transactions between incompatible payment preferences when the payer (buyer) and payee (supplier) cannot agree on any compatible payment arrangement. In some instances, execution of conversion(s) of currencies based on payment requirements of different parties can also be performed at the payer or payee systems. This intermediary (as a component that is a separate system or as a logic component part of the buyer or seller side) can either receive cryptocurrencies from the payer and disburses fiat currency to the payee, or vice versa.

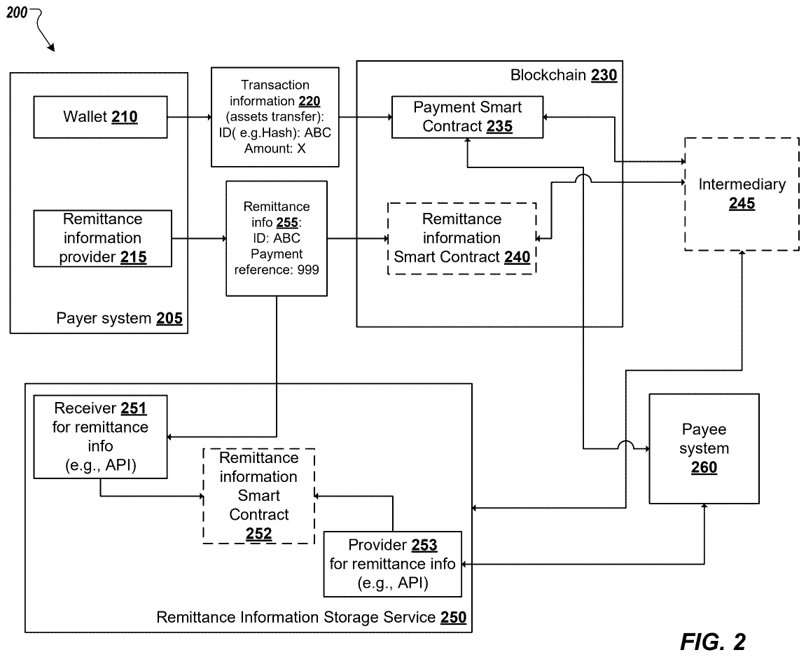

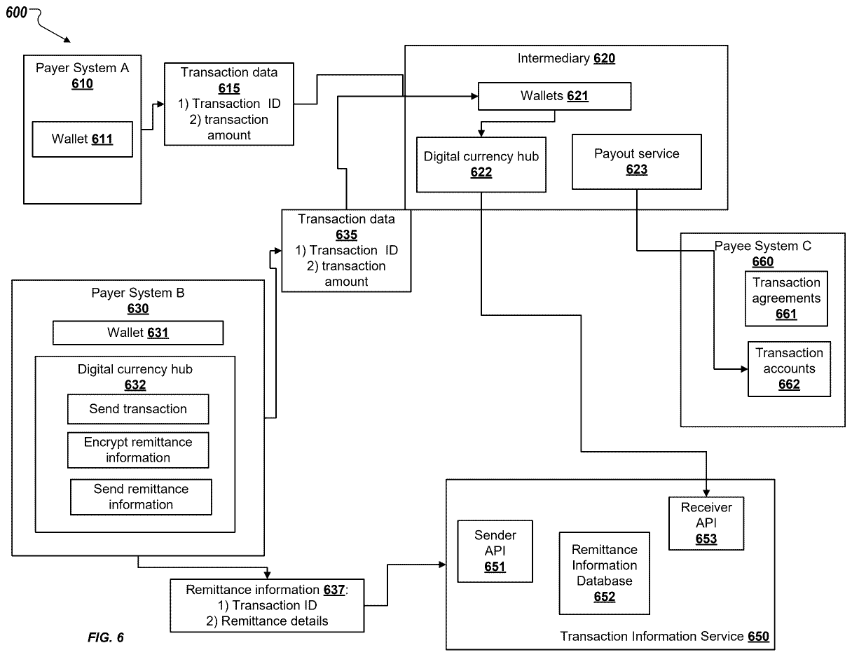

In accordance with the present implementations, the execution of payment transactions can be performed by combining the settlement of payments and essential remittance information for the payment on a decentralized ledger. In such cases, during execution of a transaction, transaction information and associated remittance information can be transferred from a payer system to a payee system in a combined manner so that the payee system obtains information for the transaction that is executed as well as the remittance. The connection between the transaction information and the remittance information can be maintained when the transaction information is published on a blockchain and the information can be provided by through the transaction execution flow (e.g., as described in relation to FIGS. 2A-C, FIG. 6). The implementations of the present disclosure support doubling down on a unified technology stack to support the association (or linkage) between the transaction data and the remittance data. Based on such association, participants in the decentralized finance sector can be provided with options to order a coherent and consistent portfolio of financial products while relying on the very same structures that can be used for publishing the transaction information when remittance information is not transferrable from the payer system to the payee system through the same flow of information (see for example FIG. 6 in relation to payer Alice).

The implementations of the present disclosure provide an agnostic approach to the structure of the remittance information exchanged and a cryptographic identification of all parties involved. These capabilities may be critical for open-loop solutions or systems that exchange information over public ledgers, where interoperability and data confidentiality are paramount. A key advantage is the flexibility to use either operator-to-operator level encryption when one or more systems are operated as-a-service, where information is encrypted with credentials (e.g., certificates) issued by the operators, or end-to-end encryption, where each party issues its own credentials on-premises so that information remains encrypted from party to party and opaque to the operators. Another advantage is the flexibility to exchange remittance information using common, standardized, or custom structures, because solutions implemented under this disclosure do not rely on operator access to specific data attributes to ensure regulatory compliance and operational excellence. Regardless of the setup, it must be aligned and homogeneous across all interacting parties.

### Transaction Execution Flow

In some instances, a transaction can be initiated so that a payment by a payer can be executed and an amount of first digital assets can be paid to a payee. The amount and the type of the digital assets to be used for the payment can be defined for the payee and/or payer. For example, the type of assets for the payment can be defined as acceptable for the payee, defined as an asset type that is the one that is a requirement when payments are made to the payee (e.g., by the payer or other payers), among other examples. In some cases, the payer may want to pay using another digital asset (e.g., a different type of a different asset, such as a different currency). For example, the payer may want to pay using a stablecoin where the payee may not accept stablecoins and instead require payment in fiat currency, or vice versa. Other payment preferences, such as the type of assets and type of distributed ledger technologies to be used, can also provide incompatibility between parties that are part of a transaction. In those cases, an intermediary can be used to mediate between the payer and payee. For example, the intermediary can be a service provider that can facilitate the exchange of cryptocurrencies or a financial institution acting as an intermediary. However, it should be appreciated that even if there are requirements for exchange of assets to execute the payment in the desired or defined currencies, the role of the intermediary can be performed by one of the parties in the transaction without the need of an intermediary.

In some instances, a payer initiates a transfer, e.g., a payment transaction to transfer funds in the form of digital assets. The transaction can be executed as a blockchain transaction. The transfer can be instructed to be performed from a noncustodial or custodial wallet of the payer to an intermediary (e.g., a mediator as described in relation to FIG. 2) through a blockchain. The payer can provide remittance information about the transaction, for example, within a central smart contract that is to be stored on the blockchain or through a reference to the remittance information as stored at a central storage service.

Generally, the payment information for a payment transaction that can include business context data, remittance data, and settlement instructions can be persisted at a public decentralized ledger (e.g., a blockchain network), or at a data storage (e.g., a central database or storage service accessible via an exposed interface (API)).

In some instances, when the payer provides the transaction information and remittance information for persisting at a blockchain, the payer can provide the associated remittance information within a central smart contract, which can be used as a primary identifier and be a unique transaction hash of the transfer. In some instances, to prevent unrelated parties from reading the remittance information stored on the blockchain, the payer can encrypt the remittance information, for example, according to an agreed protocol for encrypting the information with the intermediary. The intermediary can receive the payment transaction, for example, in a central wallet or in a dedicated wallet of any particular granularity (e.g., at the discretion of the intermediary or as prescribed by the payer or payee).

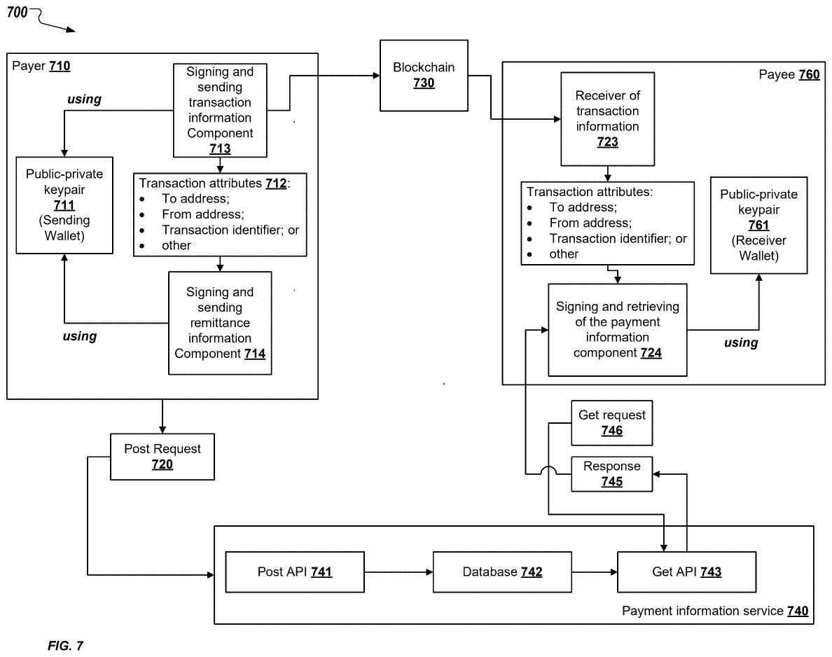

In some cases, the payer can provide transaction information, including the transferred amount to be persisted in a blockchain, but persist the remittance data and/or settlement instructions at a central storage. In that case, to protect the remittance data at the central storage, signing techniques for ensuring the confidentiality and legitimacy of the data can be applied. In some instances, the payer can construct a multi-part identifier using the transaction identifier (e.g., hash value), sender identifier (e.g., sender's address), and receiver identifier (e.g., receiver's address) from the payment transaction that can be used to determine the payer. The payer can sign the multi-part identifier (e.g., challenge message) with a private key corresponding to the sender identifier specified in multi-party identifier to prove the legitimacy of the request. When the signed data is provided to the storage with a request to an application programming interface (API) (a POST API as shown on FIG. 7), the interface can perform a verification if the signature was provided based on a private key corresponding to the sender identifier specified in the multi-part identifier. When the payee or an intermediary wants to obtain the remittance information as protected from the central storage, the payee or the intermediary can request to obtain that from an exposed API (a GET API as shown on FIG. 7). The payee or the intermediary can independently reconstruct the multi-part identifier using the transaction identifier (e.g., hash value), sender identifier (e.g., sender's address), and receiver identifier (e.g., receiver's address) from the received payment transaction. To prove the legitimacy of the request, the payee or the intermediary can sign the multi-part identifier (e.g., challenge message) with a private key corresponding to the receiver identifier specified in the multi-party identifier. When data is requested from the storage with a signed request to an application programming interface (API) (a GET API as shown on FIG. 7), the interface can perform a verification if the signature was provided based on a private key corresponding to the receiver identifier specified in the multi-part identifier. This approach ensures tamper-proofness in a way that only a legitimate owner (verifiable owner) of a receiving wallet can prove their relationship to a specific payment, and that the associated remittance information remains cryptographically anchored to the beneficiary of the payment transaction.

Furthermore, if a debtor liable for payment (an expected sender of digital assets to a payee) were to maliciously claim a real transaction by providing a different sender address to fraudulently trigger a debt relief effect from a creditor, such a claim would not be successful since the receiver (payee) will always request remittance information based on the actual sender address, receiver address, and transaction hash recorded on-chain, instead of what the sender has provided. As such, security of transactions is improved. In accordance with the present implementations, the system would rely on this multi-part identifier to determine the debtor by matching and verifying a request, and any mismatch in the fields of the multi-part identifier would cause the forged or manipulated payment information to be ignored or rejected. Therefore, even if a sender is not legitimate (not the true payer in an existing transaction), the protocol remains secure and self-validating thus ensuring that malicious or falsified payment information will not become effective.

When the payment transaction is executed successfully (as defined by a confirmation policy defined for the blockchain), the payer or an intermediary entity performing actions for the payer can use the identifier of the transaction (e.g., a unique identifier such as a hash of the payment transaction and/or other transaction attributes) to store and reference the remittance information associated with the payment transaction on the blockchain or at a central storage in accordance with implementations of the present disclosure. Based on the receipt of the information for the transaction by a payee (e.g., directly or through an intermediary entity), the payee (or the intermediary) can use the identifier for the payment transaction (as stored in the blockchain) to retrieve the associated remittance information that is either stored at the blockchain or at the central storage as discussed above. In the case that the remittance information is stored at the blockchain, the payee or intermediary can obtain the remittance information as an encrypted ciphertext from the central smart contract. Since the payee or intermediary has previously instructed the payer on how to encrypt the remittance information and is the issuer of the credential (e.g., cryptographic keys), it can decrypt the data and use it for processing the transaction. In the case that the payment is facilitated by an intermediary, the intermediary could use instructions (e.g., for settlement, conversion, forwarding, amongst others) embedded into or correlated with the remittance information to provide the payment information to the payee.

In some instances, when the remittance information is encrypted, the encryption can be performed either at the operator-to-operator level-using credentials (e.g., cryptographic public-private key pairs) issued and managed by the operators, making the data transparent to them- or end-to-end, where each client generates and manages its own credentials (e.g., on-premises), so the information remains encrypted from client to client and opaque to the operators.

### Hybrid Certificate-Based Encryption

In some instances, a hybrid cryptography approach can be used that integrates asymmetric encryption (RSA-OAEP with a 2048-bit modulus) for a secure key, and exchange and symmetric encryption (AES-256-GCM) for high-speed data confidentiality. By combining AES-256-GCM, which ensures fast encryption and decryption of large data volumes while providing integrity through authenticated encryption, with RSA-OAEP, which efficiently protects encryption keys, the solution balances strong security with optimal computational performance, while adhering to the JOSE (JavaScript Object Signing and Encryption) standard-which makes it best of breed. This approach provides the following advantages.

### Secure Certificate Exchange

Asymmetric encryption does not require to disclose any secret (private) key to the payer. Instead, only a public key is shared, which can be used for encryption but not for decryption. This eliminates the risk of unauthorized access, as only the intended recipient who holds the corresponding private key can decrypt the data.

### Preventing Pattern Vulnerabilities

By using a randomly generated symmetric key for data encryption (AES-256-GCM), the approach significantly reduces the risk of repetitive patterns that could be exploited to reconstruct the private key. Each transaction uses a unique encryption key, ensuring that even if multiple messages are encrypted for the same recipient, the underlying cryptographic security remains intact, further protecting against attacks such as pattern analysis or cryptographic key inference.

### Regulatory and Compliance Readiness

The present implementations are configured to meet industry security standards and aligns with best practices for data privacy, cryptographic security, and regulatory compliance (e.g., GDPR, PSD2, PCI-DSS).

### Encryption Process

The encryption process that can be applied when storing remittance information at the blockchain include the following phases.
1) Data Encoding

The remittance information is first serialized into a universally interoperable JavaScript Object Notation (JSON) data format and then converted to a byte array using UTF-8 encoding to ensure character set consistency.
2) Symmetric Encryption (AES-256-GCM) for data confidentiality

A random AES-256 key and a unique Initialization Vector are generated per encryption operation to ensure security against replay attacks. The remittance information is then encrypted to ciphertext with the key and Initialization Vector using AES-256-GCM.
3) Asymmetric Encryption (RSA-OAEP) for secure key transmission

The random AES-256 key is then encrypted using RSA-OAEP with a 2048-bit modulus length using the recipient's public RSA key, ensuring that only the corresponding private key can decrypt it (which is confidential and only known to the recipient).
4) Compact JWE Format Construction

The encrypted AES-256 key, Initialization Vector, and ciphertext are combined into a Compact JSON Web Encryption (JWE) structure for secure transmission. The JWE format enables seamless interoperability and is following cryptographic best practices.

### Decryption Process

The decryption of the remittance information on the side of the payee can be performed to include the following phases.
1) Compact JWE Format Deconstruction

The received Compact JWE structure is parsed into its individual components:
Encrypted AES Key
Initialization Vector (IV)
Ciphertext (Encrypted Remittance Information)
Authentication Tag (for GCM verification)
2) Asymmetric Decryption (RSA-OAEP) for key retrieval

The recipient's private RSA key can be used to decrypt the random AES-256 key, which was encrypted for secure transmission und used to encrypt the remittance information.
3) Symmetric AES-256-GCM Decryption for data recovery

The decrypted AES-256 key is used to decrypt the ciphertext using the AES-256-GCM algorithm. The Initialization Vector (IV), which was extracted from the JWE object, ensures the decryption is correctly aligned with the original encryption process. The GCM authentication tag is verified to ensure data integrity and authenticity.
4) Data Decoding

The decrypted byte array is converted back into human-readable JSON plaintext using UTF-8 decoding and then parsed into a machine-readable remittance information object.

In some instances, a ciphertext can comprise the following components/segments including:
1) JWE Header (First Segment)

Base64-encoded JSON object including metadata:
Algorithm (alg): “RSA-OAEP” (for key encryption)
Encryption Method (enc): “A256GCM” (for data encryption)
Key-ID (kid): “d4fe38d6-046b-4abc-5377-70c999a00ca7” (for key management)
2) Encrypted Key (Second Segment)

The AES-256-GCM encryption key, which is asymmetrically encrypted using RSA-OAEP. Only the recipient with the private RSA key can decrypt this to retrieve the AES key.
3) Initialization Vector (IV, Third Segment)

A random IV (Nonce) used in AES-GCM encryption, ensuring security and uniqueness for each encryption operation and prevents recurring patterns in the ciphertext, which is enhancing the cryptographic strength.
4) Ciphertext (Encrypted Data, Fourth Segment)

The actual encrypted remittance information using AES-256-GCM. Requires the decrypted AES key and IV to be deciphered.
5) Authentication Tag (Fifth Segment)

During decryption, the recipient verifies this tag to confirm that the message has not been altered by a malicious third party or an unauthorized sender.

In the case that the payment is facilitated by an intermediary, the intermediary could use instructions (e.g., for settlement, conversion, forwarding, amongst others) embedded into or correlated with the remittance information. In some cases, depending on how the payer was instructed to encrypt, the used credentials may need to be identified before the remittance information can be decrypted. To improve confidentiality, credentials can be issued individually at the transaction level. This prevents repetitive patterns that could enable tracing or cross-correlation of information.

In the case that the remittance information is stored at the central storage, it can be provided through an interface (the POST API request as shown on FIG. 7) that enforces legitimacy and obtained from an interface (the GET API request as shown on FIG. 7) that preserves confidentiality, both exposed by the central store as described above.

In some instances, the intermediary can process information for transactions at the blockchain, for example, correlate both blockchain transactions-one associated with the transaction as a payment and the other associated with the remittance information, convert the stablecoins into the fiat currency requested by the payee (or other conversion), including foreign exchange, and initiate a fiat payout to the payee using traditional methods. When the intermediary performs the payout to the payee, the intermediary can provide information for the amount of the payout (a fiat payout in the example) together with comprehensive and well-structured or unstructured remittance information as initially provided by the payer.

In the context of the present example, once the transaction is executed, the payee receives the fiat payout to its bank account, either the one specified during onboarding with the intermediary or, if provided by the payer, a bank account specified as part of the remittance information. The payee does not hold ownership or accountability of cryptocurrencies or stablecoins and may not need to report any digital assets on its balance sheet. However, can provided with sufficient information for the executed payment and associate them with transactions as instructed by the payer to provide transparency and ensure accuracy.

The present implementations provide a novel and innovative solution that uniquely combines transaction information and remittance information that is provided through the transaction flow as the transaction is recorded at a blockchain, while also supporting atomicity and consistency across both. Typically, such remittance information is not provided as part of the transaction flow and the present implementations provide an end-to-end integration of core processes between the parties that combine various sources of information in a seamless and secure manner. By supporting standardized information exchange formats such as PAIN.001, CAMT.053, or CAMT.054, it ensures deep and seamless integration with existing financial infrastructures and reduces the effort required for the setup, lowers entry barriers, and thereby simplifies the onboarding for new participants.

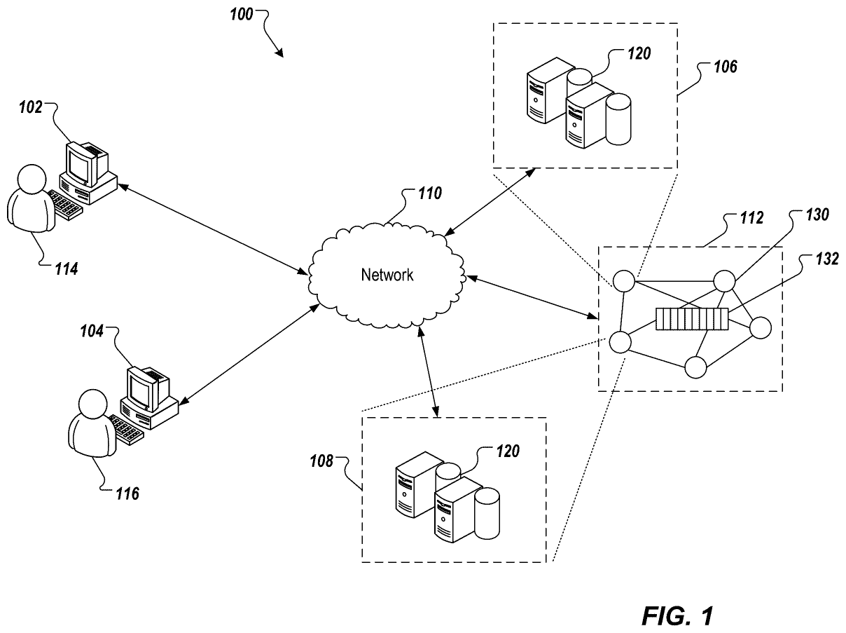

FIG. 1 depicts an example environment 100 that can be used to execute implementations of the present disclosure. In some examples, the example environment 100 enables users associated with respective systems (e.g., employees, data administrators, contractors, representatives) to manage (e.g., create, execute, close) data objects (e.g., contracts, business objects) between enterprises created by corresponding software system in a technology platform. The example environment 100 includes computing devices 102, 104, back-end systems 106, 108, a network 110, and a blockchain network 112 (e.g., consortium blockchain network). In some examples, the computing devices 102, 104 are used by respective users 114, 116 to log into and interact with the platforms and running applications according to implementations of the present disclosure.

In the depicted example, the computing devices 102, 104 are depicted as desktop computing devices. It is contemplated, however, that implementations of the present disclosure can be realized with any appropriate type of computing device (e.g., smartphone, tablet, laptop computer, voice-enabled devices). In some examples, the network 110 includes a local area network (LAN), a wide area network (WAN), the Internet, or a combination thereof, and connects web sites, user devices (e.g., computing devices 102, 104), and back-end systems (e.g., the back-end systems 106, 108). In some examples, the network 110 can be accessed over a wired and/or a wireless communications link. For example, mobile computing devices, such as smartphones can utilize a cellular network to access the network 110.

In the depicted example, the back-end systems 106, 108 each include at least one server system 120. In some examples, the at least one server system 120 hosts one or more computer-implemented services that users can interact with using computing devices. For example, components of enterprise systems and applications can be hosted on one or more of the back-end systems 106, 108. In some examples, a back-end system can be provided as an on-premises system that is operated by an enterprise or a third-party taking part in cross-platform interactions and data management. In some examples, a back-end system can be provided as an off-premises system (e.g., cloud or on-demand) that is operated by an enterprise or a third-party on behalf of an enterprise.

In some examples, the computing devices 102, 104 each include a computer-executable applications executed thereon. In some examples, the computing devices 102, 104 each include a web browser application executed thereon, which can be used to display one or more web pages of platform running the application. In some examples, each of the computing devices 102, 104 can display one or more GUIs that enable the respective users 114, 116 to interact with the computing platform.

In accordance with implementations of the present disclosure, a computing platform leverages the blockchain network 112 to facilitate data management, and to notarize data objects, such as record contracts, documents, and/or transactions between enterprises/platforms. In some implementations, the blockchain network 112 is provided by a third-party provider. In some examples, the blockchain network 112 is one of a permissionless blockchain network, and a permissioned blockchain network. In general, in a permissionless blockchain network, the identity of participants can be obfuscated (e.g., pseudonymous, anonymous), and anyone can participate, read all transactions, participate in the process of block verification to create consensus (described in further detail herein), and the like. In general, in a permissioned blockchain network, all participants are known, approved, and governed.

In general, and as introduced above, a blockchain is a ledger including records that have ever been executed in one or more contexts (e.g., a contract between multiple parties). Whereas a blockchain is a data structure for storing transactions, a blockchain network is a network of computing nodes that manage, update, and maintain one or more blockchains. A blockchain constantly grows as completed blocks are added with a new set of transactions. In some examples, a single block (or block node) is provided from one or more transactions. Blocks may be added to the blockchain in a linear, chronological order by one or more computing devices in a peer-to-peer network of interconnected computing devices that execute a consensus protocol. The peer-to-peer network can be described as a plurality of interconnected nodes, each node being a computing device that uses a client to validate and relay transactions (e.g., resource transfers, data object manipulations). Each node maintains a copy of the blockchain, which is automatically downloaded to the node upon joining the peer-to-peer network. A consensus protocol provides a secure and reliable method of updating the blockchain, copies of which are distributed across the peer-to-peer network, without the need for a central authority.

A blockchain network can be provided as a public blockchain network, a private blockchain network, or a consortium blockchain network. Multiple nodes within the blockchain network may participate in the consensus protocol and perform work to have a block added to the blockchain.

Because all users (e.g., participants in an agreement over a document) need to know all previous related data objects (e.g., contract creation, edits, signature, object versions) to validate a requested transaction to store a hash value for a data object at the blockchain network, at least a portion of the participants (e.g., users, a majority of users working with application on partner systems) must agree on which data objects and/or versions have actually occurred, and in which order. That is, consensus must be reached. For example, if two users observe different data object histories, they will be unable to come to the same conclusion regarding the validity of a transaction. In some examples, all users agree on the same rules used to validate transactions (e.g., as provided in the blockchain protocol), thus coming to a consensus.

With continued reference to FIG. 1, the blockchain network 112 is provided as a peer-to-peer network including a plurality of nodes 130, at least some of which immutably record information in a blockchain 132 (distributed ledger). Although a single blockchain 132 is schematically depicted, multiple copies of the blockchain 132 are provided and maintained across the blockchain network 112. For example, multiple nodes 130 each store a copy of the blockchain 132. In some implementations, the blockchain 132 stores information including, without limitation, contracts, transactions, supporting documents, and the like.

In accordance with implementations of the present disclosure, and as noted above, the back-end systems 106, 108 may host enterprise applications or systems that require data sharing and data privacy. The blockchain network 112 may be defined as a central component for facilitating data management and communication between partner systems.

In accordance with implementations of the present disclosure, the blockchain nodes and the blockchain network may be used for storing hash values of data objects that are generated during operations between respective entities associated with partner systems for the blockchain network. The stored hash values at the blockchain network provide a light-weight solution for data verification during data exchange. Further, evaluation of hash values is performed faster as fewer computing resources are required.

As introduced above, implementations of the present disclosure are directed to providing a framework that reduces the number of operations and evaluations that are performed when setting up a consortium or an agreement between partner systems of a blockchain network, such as the blockchain network 112 at FIG. 1. The framework may provide technical capabilities and facilitate collaboration between systems during exchange of data and communication created data objects, such as business objects, during operations of partner systems applications.

FIG. 2 depicts an example conceptual architecture 200 in accordance with implementations of the present disclosure, where transaction information is persisted in a blockchain network 230 and remittance information is maintained. In accordance with implementations of the present disclosure, the transaction information is associated with a transaction between systems of a payer and payee, and the remittance information is generated for the transaction and associated with the transaction information is provided to a payee.

In some implementations, a payer and payee can be configured with respective payer system 205 and payee system 260, and they can persist data for executed payment transaction in a blockchain 230. In some instances, the persisted data can be stored in another type of a decentralized ledger, where blockchain is used here for the sake of the example, and the implementations of the present disclosure can be configured to work with other types of databases distributed across multiple nodes or location where remittance information associated with the transaction can be persisted as well so that the remittance information can be provided directly to the payee and be associated with the particular payment transaction. This can support transparency of transaction execution, efficiency in processing payment transactions as well as security during transaction execution. In such a manner, remittance data is protected and accessible only to the authorized parties as previously described in the present patent application.

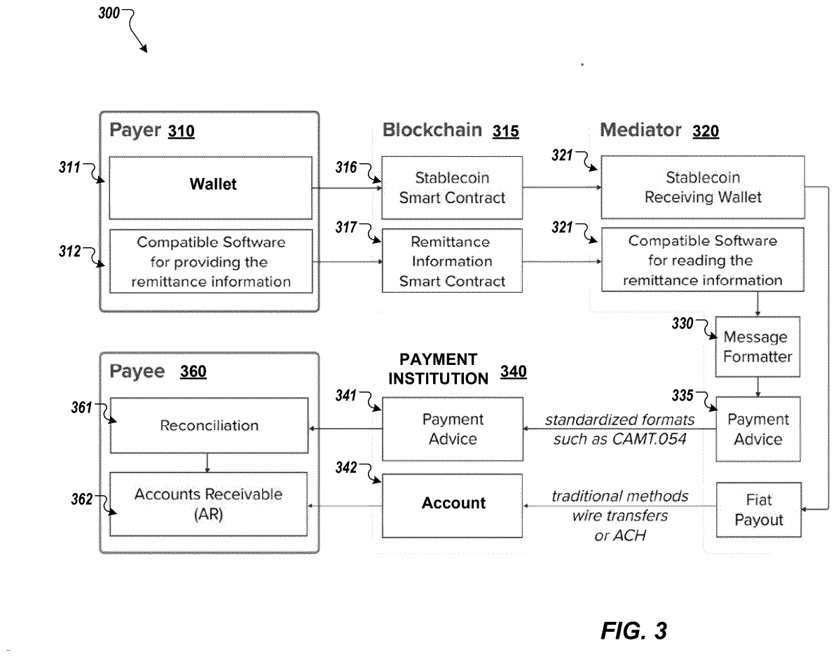

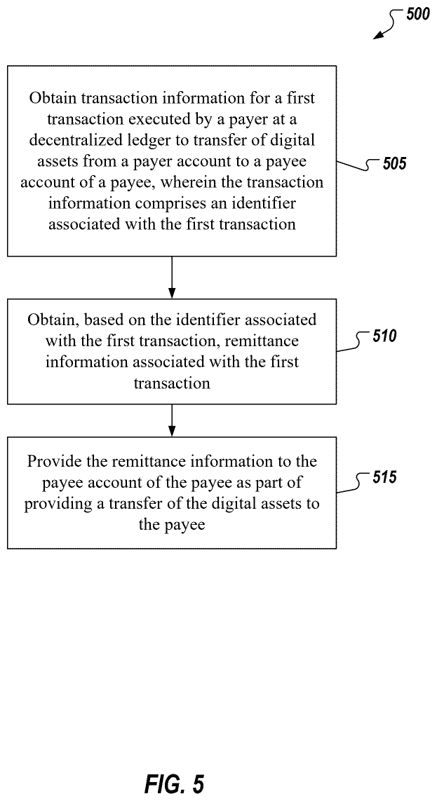

For example, the method as described in relation to FIG. 5 can be executed at a computer environment embodying the conceptual architecture 200 of FIG. 2. The payer, payee, blockchain, intermediary, and the storage service can be substantially similar as same entities described in relation to FIGS. 3, 5, 6, 7.

The payer system 205 includes a wallet 210 and a remittance information provider 215. When a transaction is to be executed between the payer system and the payee system 260 via the blockchain 230, funds are transferred between the accounts (e.g., wallets) at the payer system and the payee system and remittance information for the amount of the funds and/or reference to a payment as stored by the payer system 205. The wallet 210 can be used to instruct the transaction and transaction information 220 can be provided for the transferred funds or assets by the payer to the payee. The transaction information 220 can include an identifier, such as a hash value, and an amount of the transferred assets. A payment smart contract 235 can be recorded at the blockchain 230, and it can be communicated with the payee system 260, either directly or through an intermediary 245, as discussed throughout the present disclosure.

The remittance information provider 215 of the payer system 205 is a service that can generate remittance information 255 associated with the transaction for which the transaction information 220 is generated by the wallet 210. The remittance information 255 can be associated with the transaction information 220 based on including the same identifier for the transaction, e.g., the same transaction hash value. The remittance information 255 can include a particular payment reference, e.g., identified by a payment reference identifier, and such data can be used by the payee system 260 to understand the context of the transferred funds, for example, to associate them with a particular transaction and for a particular agreement between the payer and the payee.

In some instances, the remittance information 255 can be stored at the blockchain 230, or provided to a remittance information storage service 250, through which the remittance information can be obtained by the payee system 260. The remittance information can be persisted at the blockchain 230 as a remittance information smart contract 240, or at the remittance information smart contract 252 at the remittance information storage service 250.

In accordance with implementations of the present disclosure, a transaction initiated through the payer system 205 can be executed with or without the support of an intermediary, where the use of an intermediary would not change the solution, and the operations performed by the intermediary can be distributed between the payer and/or payee system. In some cases, if an intermediary can be used, the intermediary can facilitate transactions between incompatible payment preferences when the payer (buyer) and payee (supplier) cannot agree on any compatible payment arrangement. The intermediary 245 can be a component that is a separate system or as a logic component part of the buyer or seller side. For example, the intermediary 245 can support a transaction where the payer system provides assets in one currency and the payee system is compatible with another currency, so that the intermediary 245 can, for example, receive cryptocurrencies from the payer and disburses fiat currency to the payee, or vice versa.

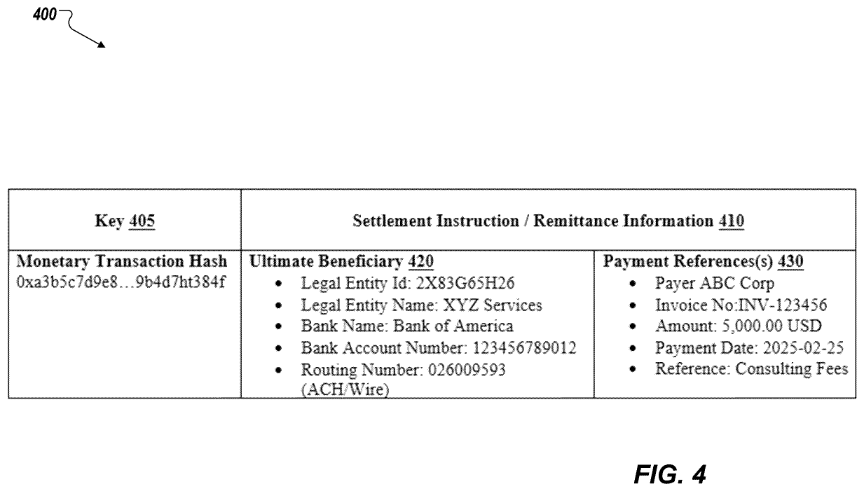

In some instances, when the remittance information is stored at the blockchain 230, it can be stored in an optimized blockchain format to reduce the size of data stored at the blockchain. For example, the format can be as shown on FIG. 4. The example remittance information format 400 of FIG. 4 defines for the format structure to include a key section 405 and a remittance information section 410. The remittance information section 410 can also be referred to as a settlement instruction. The remittance information section 410 can include an ultimate beneficiary identifying information for the account and account details of the payee, including legal entity identifier, legal entity name, bank name, bank account number, a routing number, etc. The remittance information section 410 can also include a payment reference 430 that identifies the payer with a company name, address, or more. Further, the payment reference 430 can include information about an invoice or receipt (or other document) relevant to the executed transaction, an amount of the transaction, a time stamp of the date of the payment, and a reference for the type of services or products associated with the transaction. For example, the payee can provide consulting services to the payer, and the payer identifies that the payment includes consulting fees in the reference of the payment reference 430.

In some instances, when the remittance information 255 is not provided to the blockchain 230, the remittance information 255 can be provided to a receiver 215 instantiated at the remittance information storage service 250, that can receive the information 255 and store it as a remittance information smart contract 252. In some instances, the payee system 260 can send a request for obtaining remittance information associated with a transaction by providing the identifier of the transaction (as part of the transaction information). The payee system 260 can request that from the blockchain 230 or from the remittance information storage service 250, depending on which is the storage to persist the remittance information. When the remittance information is stored at the remittance information storage service 250, the provider 253 part of the remittance information storage service 250 can receive the request, and obtain the remittance information smart contract, such as the remittance information smart contract 252 that corresponds to the identifier of the transaction that is requested. In some instances, the provider 253 can be an application programming interface (API) that can be requested to provide the data. The remittance information can be stored at the remittance information storage service 250 by the payer system 205 and through a receiver 251 at the remittance information storage service 250. In some instances, if the payer system 205 and the payee system 260 are configured to interact through an intermediary 245, the intermediary 245 may also be setup to request remittance information from the blockchain 230 or the remittance information storage service 250 in a similar way as to the configuration provided for the payee system. The intermediary 245 can send a request to the provider 253 to obtain remittance information by providing an identifier of a transaction, as obtained through a smart contract, such as the payment smart contract 235, stored at the blockchain 230.

FIG. 3 depicts an example computer architecture 300 in accordance with implementations of the present disclosure, where a payment process between a payer 310 and a payee 360 is facilitated by an intermediary (a mediator 320) and remittance information 317 to the transaction is maintained at a blockchain network. In the example computer architecture 300, the payer 310, payee 360, and mediator 320 represent systems of a payer, payee and mediator that are configured to communicate and execute processes related to transactions (e.g., exchange of funds between parties) in accordance with implementations of the present disclosure. The payer 310 and the payee 360 can be substantially similar to the payer 205 and the payee 260 of FIG. 2. The mediator 320 can be substantially similar to the intermediary 245 of FIG. 3. The blockchain 315 can be substantially similar to the blockchain 230 of FIG. 2.

In some instances, the role of the mediator 320 can be performed by a MICAR-regulated crypto asset service provider or a bank. In this example computer architecture 300, the payer associated with the payer system 310 can be a buyer of products, services, or combination thereof), and the payee is the supplier (provider of products or services).

In some instances, a transaction between the payer 310 and the payee 360 systems can be executed through the blockchain 315 network, in a substantially similar manner as described in relation to FIG. 2.

The payer 310 system can include a wallet 311 for holding funds, which can be a custodial or a non-custodial wallet for holding Stablecoins. The payer 310 system can include a compatible software 312 for providing the remittance information associated with transactions that handled between the payer 310 and other payees, including the payee 360.

The current example architecture 300 includes the blockchain 315, but other types of distributed ledgers can be used, as described in relation to FIG. 2. In the current example, the blockchain 315 may rely on different standards for handling an execution of a transaction on a blockchain. For example, the ERC20 standard has become the dominant payment medium on Ethereum Virtual Machine (EVM) compatible blockchains and is used as an example in the present disclosure. However, other standards can be applicable and compatible with the present disclosure so as to ensure a combination of smart contract functions and data logging (e.g., event logging), to ensure transparency, traceability, and consistency.

### Correlation of Blockchain Transactions

In accordance with implementations of the present disclosure, when the underlying protocol used for communication between the payer 310 and the mediator 320 does not support providing of remittance information, the blockchain 315 can be configured to use two separate transactions to store information for the transferring of funds, and another one to store remittance information. The transaction smart contract 316 stored at the blockchain 315 can be a stablecoin smart contract or other and can substantially correspond to the payment smart contract 235 of FIG. 2. In general, a basic software wallet used by a payer 310 may not support functionality for providing the remittance information generally, and such configuration for storing two separate transactions can facilitate the distribution of remittance data and maintaining its association with the transaction information. Such sharing of transaction data and remittance information can be performed in a substantially similar manner as described in FIG. 2.

In some instances, a smart contract managing the remittance information, i.e., remittance information smart contract 317, can include two functions, one for the payer 310 to set the remittance information and another one for the mediator 320 to retrieve it:
setRemittanceInformation(bytes32 txHash, string data)—Stores encrypted remittance information for a transaction identified by using a transaction identifier, e.g., a hash.
getRemittanceInformation(bytes32)—Retrieves encrypted remittance information for the transaction and associated with the transaction identifier (e.g., the hash value).

The remittance information smart contract 317 maintains a persistent mapping that associates the identifier of the transaction with the corresponding remittance information as encrypted ciphertext as presented below in Table 1.

TABLE 1
Mapping(bytes32 => string)

| Transaction identifier (txHash) | data |
|---|---|
| 0x4711 . . . 815987654 | Remittance information as |
| | encrypted ciphertext |
| 0xd9b8 . . . eefb29c7b | Remittance information as |
| | encrypted ciphertext |
| . . . | . . . |

### Reference Contract

Table 2 below represents a minimalistic reference implementation of the remittance information smart contract 317:

```
TABLE 2
// SPDX-License-Identifier: MIT
  pragma solidity \hat{ }0.8.0;
contract RemittanceInformationContract {
  mapping(bytes32 => string) private map;
function setRemittanceInformation(bytes32 txHash, string memory data)
public {
    map[txHash] = data;
function getRemittanceInformation(bytes32 txHash) public view returns
(string memory) {
    return map[txHash];
    }
}
```

In some instances, the mediator 320 can obtain the transaction information from the stablecoin smart contract 316 and store it at the stablecoin receiving wallet 321. The stablecoin receiving wallet 321 can provide instructions for a payout (e.g., fiat payout) to an account 342 at a payment instruction 340. The account 342 is of the payee 360 where funds can be transferred to the payee 360.

The mediator 320 can include compatible software 321 for reading the remittance information as obtained from the remittance information smart contract 317 and using that obtained remittance information to create a message, through a message formatter 330, and provide a payment advice 35 to the payment institution 340 through a standardized message. The payment institution 340 can store the provided payment advice 335 as a record in a database that is the payment advice 341 stored at the payment institution 340. The payment advice 341 as well as funds from the account 342 are instructed to be provided to the payee, so that accounts receivable 362 on the payee 360 system can acknowledge the executed transaction, and account reconciliation can be performed to confirm that the payer had provided the funds according to the agreement of the transaction, and the funds can be associated with the remittance information to confirm the state.

### Remittance Information

FIG. 4 depicts an example blockchain optimized format 400 for storing remittance information at a blockchain, such as the blockchains described in relation to FIGS. 1, 2, and 3.

In some implementations, a blockchain-optimized format, as shown on FIG. 4, can be used to act as an intermediary layer that carries all remittance and transaction information, enabling the consistent reconstruction of standardized formats that the payee may require, such as ISO 20022 PAIN.001 (Payment Initiation) or CAMT.054 (Payment Reporting). This approach ensures that blockchain transactions remain efficient, cost-effective, and scalable, while still meeting the compliance and reconciliation requirements of traditional financial systems.

### Reference Format

The example blockchain optimized format 400 is a structured intermediary format that supports consistent conversion into ISO 20022 PAIN.001 for payment initiation and CAMT.054 for reporting, ensuring full compatibility with the traditional banking interfaces required by both the payer and the payee.

It should be appreciated that while the reference format of FIG. 4 and outlined above efficiently meets the requirements of the highlighted stablecoin-to-fiat scenario, the solution is designed to support any format or structure, as long as all participating parties are aligned and adhere to it. In some instances, such format may not be applied when the remittance information is stored in a storage service as described above.

### Example Mapping to PAIN.001 (Payment Initiation Request—ISO 20022)

The PAIN.001 format is an XML-based payment initiation message standard defined by ISO 20022 and commonly used in SEPA (Single Euro Payments Area) and global financial transactions. It is primarily utilized by businesses and organizations to initiate credit transfers (such as supplier payments or salary disbursements) from their bank accounts. The format standardizes payment information, ensuring interoperability between corporate ERP systems, banks, and financial institutions. PAIN.001 files include structured payment details, including payer and payee information, payment amounts, currency, and execution dates, facilitating automated and efficient bulk payment processing and straight-through processing (STP) across financial networks.

Table 3 below represents how the fields from the reference format can map to PAIN.001:

```
TABLE 3
<CdtTrfTxInf>
  <PmtId>
    <InstrId>0xa3b5c7d9e8...9b4d7th384f</InstrId> <!-- Blockchain
Transaction Hash -->
    <EndToEndId>INV-123456</EndToEndId> <!-- Invoice Number -->
  </PmtId>
  <Amt>
    <InstdAmt Ccy=“USD”>5000.00</InstdAmt> <!-- Payment
    Amount -->
  </Amt>
  <Cdtr>
    <Nm>XYZ Services</Nm> <!-- Payee Name -->
  </Cdtr>
  <CdtrAcct>
    <Id>
      <Othr>
        <Id>123456789012</Id> <!-- Payee Bank Account -->
      </Othr>
    </Id>
  </CdtrAcct>
  <CdtrAgt>
    <FinInstnId>
      <BIC>BOFAUS3N</BIC> <!-- Bank Identifier Code (BIC) -->
      <ClrSysMmbId>
        <MmbId>026009593</MmbId> <!-- Routing Number -->
      </ClrSysMmbId>
    </FinInstnId>
  </CdtrAgt>
  <RmtInf>
    <Strd>
      <CdtrRefInf>
        <Ref>Consulting Fees for February 2025</Ref> <!-- Payment
        Reference -->
      </CdtrRefInf>
    </Strd>
  </RmtInf>
</CdtTrfTxInf>
```

### Example Mapping to CAMT.054 (Payment Reporting—ISO 20022)

The CAMT.054 format is an ISO 20022 XML standard used for cash management reporting, specifically for providing detailed transaction-level information about account movements. It is commonly utilized by banks to deliver debit and credit notifications to corporate customers, helping them reconcile incoming and outgoing payments efficiently. Unlike CAMT.053, which provides an end-of-day account statement, CAMT.054 focuses on real-time or intra-day reporting, allowing businesses to track individual transactions such as direct debits, incoming payments, chargebacks, and bank fees as they occur. This format is widely used in SEPA (Single Euro Payments Area) and global banking for automated reconciliation, cash flow monitoring, and financial reporting within ERP and treasury management systems.

Table 4 below represents how the fields from the reference format could map to CAMT.054:

TABLE 4

```
<Stmt>
  <TxnSmry>
    <TtlNtryAmt>
      <Amt Ccy=“USD”>5000.00</Amt> </TtlNtryAmt>
  </TxnSmry>
  <Ntry>
    <Amt Ccy=“USD”>5000.00</Amt>
    <CdtDbtInd>CRDT</CdtDbtInd> <BkTxCd>
      <Prty>
        <Cd>ACH</Cd> </Prty>
    </BkTxCd>
    <RltdPties>
      <Cdtr>
        <Nm>XYZ Services</Nm> </Cdtr>
      <Dbtr>
        <Nm>ABC Corp</Nm> </Dbtr>
    </RltdPties>
    <RltdAgts>
      <CdtrAgt>
        <FinInstnId>
          <BIC>BOFAUS3N</BIC> </FinInstnId>
      </CdtrAgt>
    </RltdAgts>
    <RmtInf>
      <Strd>
        <CdtrRefInf>
          <Ref>INV-123456</Ref> </CdtrRefInf>
      </Strd>
    </RmtInf>
  </Ntry>
</Stmt>
```

FIG. 5 depicts an example flow 500 for storing remittance information during payment execution in accordance with implementations of the present disclosure. The flow 500 can be executed in the context of a computing environment as described in relation to FIGS. 2, 3, 6, and 7.

At 505, transaction information for a first transaction executed by a payer at a decentralized ledger (e.g., blockchain) is obtained. The transaction is for transferring digital assets (funds) from a payer account to a payee account of a payee. The transaction information includes an identifier (e.g., generated based on one or more of a hash value of the transaction, an identifier of a sender, timestamp, transaction amount, among other example transaction attributes) of the first transaction. In some instances, the transaction information can be obtained at an intermediary, for example, such as the intermediary described in relation to FIGS. 2 and 3. The transaction information can be such as the transaction information 220 of FIG. 2, or transaction data 635 of FIG. 6

At 510, remittance information associated with the first transaction is obtained based on the identifier of the first transaction. The remittance information can be obtained from the decentralized ledger or from a storage service as discussed in relation to FIGS. 2, 3, 6, 7.

In some instances, the remittance information is associated with the first transaction using the identifier associated with the first transaction that is derived from at least one transaction attribute of the first transaction. For example, the at least one attribute comprises one or more of: a transaction identifier, a sender identifier, a receiver identifier, a timestamp, or a transaction amount.

The obtaining of the remittance information at the payee system can include decrypting the remittance information as provided by the decentralized ledger according to an agreed upon protocol for encryption. For example, the encryption and decryption of remittance information can be performed as described in relation to FIG. 7.

In some instances, the remittance information is generated by the payer in an optimized format (e.g., as described with reference to FIG. 4) for the decentralized ledger and stored at the decentralized ledger by creating a smart contract published on the decentralized ledger as associated with the first transaction. In some instances, the obtaining of the remittance information at the payee system can include invoking a smart contract stored at the decentralized ledger by providing the identifier associated with the first transaction. In some instances, the remittance information is not stored at the decentralized ledger but rather at a storage service, such as the remittance information storage service 250 of FIG. 2. In such a case, obtaining the remittance information can be performed by requesting the remittance information from the storage service by providing the identifier of the first transaction. The generation and storage of the remittance information can be performed as described in relation to FIGS. 2, 3, 6, and 7. The remittance information can include the identifier of the first transaction, which can comprise a combination of a transaction identifier, a sender identifier, and a receiver identifier associated with the first transaction. The first transaction can be signed with a private key corresponding to the sender identifier, as described in relation to FIG. 7. The remittance information is obtained based on validating a signed request based on matching receiver identifier in the identifier associated with the first transaction and the received identifier in the remittance information.

At 515, the remittance information is provided to the payment account of the payee as part of providing a transfer of the digital assets to the payee.

In some instances, providing the remittance information comprises processing the transaction information to identify payment requirements associated with the payee, determining a type of digital assets to be used for performing a payment to the payee based on the identified payment requirements; and instructing a transfer of an amount of the type of digital assets to an institution.

FIG. 6 depicts an example conceptual architecture 600 where remittance information is persisted at a central database service in accordance with implementations of the present disclosure. FIG. 6 depicts an example where one payer (Alice) associated with the payer system A 610 does not persist remittance information when executing a blockchain transaction, and another payer (Bob) associated with the payer system B 630 that persists remittance information associated with another blockchain transaction at a centralized storage service, i.e., transaction information service 650.

The payer system A 610 of payer Alice includes a wallet 610 and when a transaction is instructed through the wallet 611, the transaction data 615 associated with the transaction can be provided to an intermediary 620 that is setup for an intermediary for the interaction between payer Alice and a payee, associated with Payee System C 660. In this case, the payer system A 610 is not configured to provide remittance information about the transaction, and the transaction data 615 includes the transaction identifier and a transaction amount.

As shown, when a payment is instructed by the payer system B (in other words, Bob's payment is received), the payment includes information about an amount of the payment and remittance details (e.g., a payment reference). The payment system B is configured with a digital currency hub 632 to provide instructions for sending the transaction as well as remittance information. Alice's payment does not include a remittance information as part of the transaction data 615 since the remittance information was not maintained in connection with the transaction information during the payment transaction flow.

The payer system B 630 of payer Bob is configured with a wallet 631 and the digital currency hub 632, so that when a transaction is executed, transaction data 635 including an identifier associated with the transaction and a transaction amount, is provided to an intermediary 620, which is also configured with a digital currency hub 622 and can process the transaction data 635 as well as the transaction data 615 sent by the payer system A. The intermediary 620 can provide the transaction data from the transaction data 615 and/or the transaction data 635 to the Payee System C 660 through the payout service 623, so that the data is stored at the transaction accounts 662 of the payee. The payee system C 660 include also transaction agreements 661 that are associated with transactions that are agreed, yet to be executed, or already executed.

The intermediary 620 can receive information about transactions at the wallet 621, and can process the information to communicate with the payee system C 660 or with the transaction information service 650. When the intermediary 620 received the transaction data 615, the intermediary 620 can look for remittance information by querying the transaction information service 650 through the digital currency hub 622. Since the payer system A had not maintained remittance information associated with the transaction data 615 at the transaction information service 650, the digital currency hub 622 cannot obtain remittance information when sending a request to the receiver API 653.

The intermediary 620 is an example of a mediator that can facilitate stablecoin-to-fiat payments, linking monetary transactions with remittance information provided via smart contracts on-chain for accurate reconciliation. By aligning with widely adopted banking and financial industry standards such as ISO 20022 (including PAIN.001 & CAMT.054), this solution facilitates an unparalleled end-to-end transmission of essential remittance information, ensuring seamless compatibility and deep integration with corporate systems (ERP system) and banking infrastructure on both ends.

The payer System B provides the remittance information 637 to the transaction information service 650 through the sender API 651, and the remittance information 637 is stored at the remittance information database 652 and can be provided upon request, including an identifier of the transaction with which it is associated. In the present example, when the transaction ID of the transaction data 635 is provided as part of a request at the receiver API 653, the remittance information 637 can be identified, since the identifiers match. The intermediary 620 can obtain the remittance information 637 for the transaction associated with transaction data 635 and provide it to the payee System C 660, in a similar way as described throughout the present disclosure and for example, as described in relation to FIGS. 2, 3, and 5.

Operator-Level Encryption with a Shared Certificate

From a convenience standpoint, sharing a single certificate across all payers would be the easiest approach; however, this requires trusting the paying client to accurately specify their identity within the remittance information payload.

Since the only verifiable information the intermediary 620 receives is the signature generated during encryption of the transaction information using the certificate it has provided with the payer, the intermediary 620 must rely on the payer (client) to provide a legitimate entity identifier. This introduces a potential risk of identity misrepresentation or fraud, as there is no independent verification of the provided identity using the common cryptographic signature, for example, for Alice and Bob as payers.

Table A below represents an example breakdown of example master data and the data in transit between the two payers A and B in the context of two transactions where a shared certificate is used for encryption.

TABLE A

| | Information | Mediator |
|---|---|---|
| Payer | Exchange | Master Data |
| Alice | | Alice |
| Certificate ID | Trustworthy Signature Data: | Certificate ID |
| 368A6G3452 | Certificate ID = 368A6G3452 | 368A6G3452 |
| Payer ID | Untrusted Client Data: | Payer ID |
| 8765 | Payer ID = 8765 | 8765 |
| Bob | | Bob |
| Certificate ID | Trustworthy Signature Data: | Certificate ID |
| 368A6G3452 | Certificate ID = 368A6G3452 | 368A6G3452 |
| Payer ID | Untrusted Client Data: | Payer ID |
| 9153 | Payer ID = 9153 | 9153 |

Client-Level Encryption with Individually Issued Certificates

Issuing payer-specific peer-level certificates significantly strengthens protection against identity misrepresentation and fraud by eliminating the need to trust the client for providing legit identification attributes alongside the remittance information. Since encryption generates a trustworthy signature that can be traced back to the certificate issued to the payer, the mediator can reliably identify the payer. Any attempt by a third party or a fraudulent payer to tamper with the signature or data would be detected by the mediator, enabling appropriate security measures to be taken.

Table B below is an example breakdown of example master data and data in transit when payer A and B use individually issued certificates.

TABLE B

| | Information | Mediator |
|---|---|---|
| Payer | Exchange | Master Data |
| Alice | | Alice |
| Certificate ID | Trustworthy Signature Data: | Certificate ID |
| 834H2K1826 | Certificate ID = 834H2K1826 | 834H2K1826 |
| | Untrusted Client Data: | |
| Bob | | Bob |
| Certificate ID | Trustworthy Signature Data: | Certificate ID |
| 752G3Z9523 | Certificate ID = 752G3Z9523 | 752G3Z9523 |
| Payer ID | Untrusted Client Data: | Payer ID |
| 9153 | Payer ID = 9153 | 9153 |

FIG. 7 depicts an example signature-based approach for verifying legitimacy in posting and retrieving payment information in a centralized service setup. FIG. 7 depicts an example computer environment 700 including systems such as payer 710 system, payee 760 system, a payment information service 740, and a blockchain 730. These systems can be configured as described in relation to Payer System B 620 of FIG. 6, or as described for FIGS. 2, 3, and 5, as well as in relation to storing remittance information at a storage service, as for example, at the remittance information storage service 250 of FIG. 2 or the transaction information service 650 of FIG. 6. The payee 760 system can be substantially the same as the payee system described in relation to FIG. 2, 3, 5, or 6.

The example computing environment 700 depicts an example where the remittance information is stored at a storage service, rather than at a blockchain (see FIG. 2 for both options). According to the present embodiment, signing techniques can be implemented to improve security and maintain confidentiality of the transaction data while also ensuring tamper-proofness in a way that only the legitimate owner of an account (e.g., wallet) can prove their relationship to a specific transaction, and that the associated data remains cryptographically anchored to the original transaction.

Implementations of the present disclosure bridge payment transactions (e.g., stablecoin to fiat transactions) alongside distributed ledger-based reconciliation, addressing incompatible payment preferences in cross-technology, cross-border, and multi-currency relationships.

The payer 710 system is configured to generate an identifier of a transaction, for example, as a multi-part identifier as described in the present disclosure. For example, the multi-part identifier can be generated by using a transaction hash, a sender identifier, a receiver identifier that are obtained from the transaction. The transaction information can be signed, at a signing and sending transaction information component 713, with a private key corresponding to the sender account (or wallet), i.e., the address of the payer, and send to a blockchain 730. The sending of the signed transaction information can be done to provide legitimacy of the request when sent to the blockchain 730. The private key can be obtained from the public-private keypair 711 of the sending wallet for the transaction of the payer. The transaction attributes 712 of the generated transaction can include one or more of: a transaction identifier, a sender identifier such as an address of the sender (from address), a receiver identifier (e.g., to address), a timestamp, or a transaction amount.

The payer 710 system includes a signing and sending of remittance information component 714 that is configured to sign, with a private key corresponding to the sending account, and send the signed remittance information through a post request 720 to the payment information service 740. The payment information service 740 provides a post API 741 and a get API 743, where post or get requests can be sent to provide or obtain data from a database 742 that stored remittance information persisted for relevant transactions executed by payer systems, such as the payer 710 system.

When the remittance information associated with a particular transaction (identifier by an identifier of the transaction) is stored at the database 742, the payee 760 system can send a get request 746 to the get API 743, to obtain the remittance information as a response 745 and process it. The get request 746 can include as part of the request the transaction identifier of the transaction, for which the payer 760 system wants to obtain remittance information. Such a transaction identifier can be obtained by the payer 760 system through the transaction information obtained from the blockchain 730. The payer 760 system includes a receiver of transaction information 723, that is configured to obtain signed transaction information as stored at the blockchain 730 and process the transaction information to obtain an identifier of the transaction and generate the get request 746. The remittance information that is received at the payer 760 system from the response 745 can be retrieved at the signing and retrieving of the remittance information component 742. The retrieval can be performed based on using the public-private keypair of 761 of the receiver wallet of the payee 760.

The post request 720 can include a multi-part identifier of the transaction, a signature provided by the sender, and payment information, for example, as shown at Table 5 below.

TABLE 5
POST Request

Multi-Part Identifier
□ Sender 0x6743C . . . e9A6e
□ Receiver: 0x7b91E . . . 68092
□ Transaction: 0x5fc58 . . . c925e
Signature provided by Sender
0x21fbf0696d5e0aa2ef41a2b4ff
b623bcaf070461d61cf7251c7416
87c1bc021cd318c734c51ae29374
f2beb0e6f2dd49b4b41c
Remittance Information(s)
□ Payer: ABC Corp
□ Payee XYZ Services
□ Amount: 5,000.00 USD
□ Payment Date: 2025-02-25
□ Reference: INV-123456

When the post request 720 is sent to the post API, the post API 741 can verify the sender based on the sender identifier included in the multi-part identifier and the signature provided by the sender.

In some instances, the database 742 can store records for transactions for which remittance information is provided by the payer 710 system through the post API 741. For example, a record at the database 742 can be as presented on Table 6 below.

Database

Multi-Part Identifier
□ Sender 0x6743C . . . e9A6e
□ Receiver: 0x7b91E . . . 68092
□ Transaction: 0x5fc58 . . . c925e
Remittance Information(s)
□ Payer: ABC Corp
□ Payee: XYZ Services
□ Amount: 5,000.00 USD
□ Payment Date: 2025-02-25
Reference: INV-123456

The get request 746 can include a multi-part identifier section, and a signature section. The multi-part identifier section can include an identification of the sender (the payer), the receiver (the payee), and the transaction identifier (e.g., hash value). The signature can be provided by the sender to authenticate the sender. The get request 746 can be for example, as shown at Table 7 below:

TABLE 7
GET Request

Multi-Part Identifier
□ Sender: 0x6743C . . . e9A6e
□ Receiver: 0x7b91E . . . 68092
□ Transaction: 0x5fc58 . . . c925e
Signature provided by Receiver
0x84fbf0696d5e0aa2ef41a2b4ff
b623bcaf070461d61d61cf7251c7416
1f82fec3a4370854bc0a34b3ab4
87c1bc021cd318c734c51ae29374
t8beb0e6f2dd74b3bf28z

When the get request 746 is received at the get API 743, the get API 743 can verify the request by checking the receiver and the signature provided by the receiver, so as to check that the signature was provided by the receiver address specified in the multi-part identifier.

The response 745 includes remittance information that can include for example information about the name of the payer and the name of the payee, an amount of the transaction, a transaction date or time, and reference of a document associated with the transaction, such as an invoice. The response 745 can be for example, as shown at Table 8 below:

TABLE 8
Response
Remittance Information(s)

□ Payer: ABC Corp
□ Payee: XYZ Services
□ Amount: 5,000.00 USD
□ Payment Date: 2025-02-25
□ Reference: INV-123456

This approach ensures tamper-proofness in a way that only the legitimate owner of a wallet can prove their relationship to a specific transaction, and that the associated transaction and remittance data remains cryptographically anchored to the original transaction. Furthermore, if a payer (sender) were to maliciously claim a real transaction by providing a different sender address to fraudulently trigger a debt relief effect from a creditor, this manipulation would fail. The reason is that the the receiver (payee) will request remittance information based on the actual sender address, receiver address, and transaction hash recorded on-chain, instead of what the sender has provided. Because the system relies on such multi-part identifier to match and verify the requests, any mismatch in these fields would cause the forged or manipulated payment information to be ignored or rejected. Therefore, even if the sender is not legitimate, the protocol remains secure and self-validating-ensuring that malicious or falsified remittance information will never become effective.

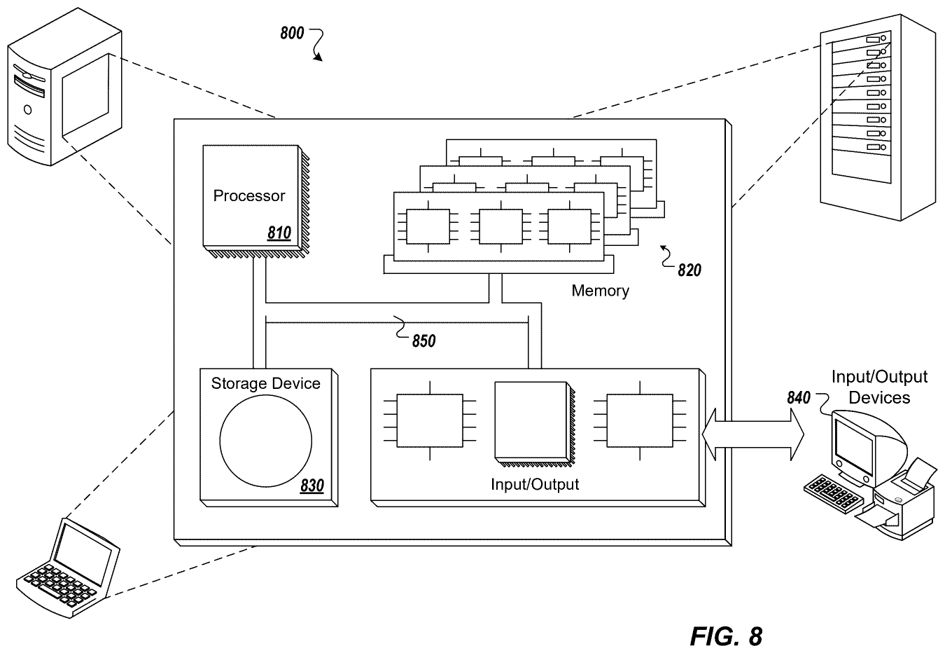

Referring now to FIG. 8, a schematic diagram of an example computing system 800 is provided. The system 800 can be used for the operations described in association with the implementations described herein. For example, the system 800 may be included in any or all of the server components discussed herein. The system 800 includes a processor 810, a memory 820, a storage device 830, and an input/output device 840. The components 810, 820, 830, 840 are interconnected using a system bus 850. The processor 810 is capable of processing instructions for execution within the system 800. In some implementations, the processor 810 is a single-threaded processor. In some implementations, the processor 810 is a multi-threaded processor. The processor 810 is capable of processing instructions stored in the memory 820 or on the storage device 830 to display graphical information for a user interface on the input/output device 840.

The memory 820 stores information within the system 800. In some implementations, the memory 820 is a computer-readable medium. In some implementations, the memory 820 is a volatile memory unit. In some implementations, the memory 820 is a non-volatile memory unit. The storage device 830 is capable of providing mass storage for the system 800. In some implementations, the storage device 830 is a computer-readable medium. In some implementations, the storage device 830 may be a floppy disk device, a hard disk device, an optical disk device, or a tape device. The input/output device 840 provides input/output operations for the system 800. In some implementations, the input/output device 840 includes a keyboard and/or pointing device. In some implementations, the input/output device 840 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

1. A computer implemented method comprising:
obtaining transaction information for a first transaction executed by a payer at a decentralized ledger to transfer of digital assets from a payer account to a payee account of a payee, wherein the transaction information comprises an identifier associated with the first transaction;
obtaining, based on the identifier associated with the first transaction, remittance information associated with the first transaction; and
providing the remittance information to the payee account of the payee as part of providing a transfer of the digital assets to the payee.

2. The method of claim 1, wherein the remittance information is associated with the first transaction using the identifier derived from at least one transaction attribute of the first transaction.

3. The method of claim 2, wherein obtaining the remittance information comprises decrypting the remittance information according to an agreed upon protocol for encryption.

4. The method of claim 3, wherein the remittance information is generated by the payer in an optimized format for the decentralized ledger and stored at the decentralized ledger by creating a smart contract published on the decentralized ledger as associated with the first transaction.

5. The method of claim 2, wherein the at least one attribute comprises one or more of:
a transaction identifier, a sender identifier, a receiver identifier, a timestamp, or a transaction amount.

6. The method of claim 1, wherein obtaining the remittance information comprises:
invoking a smart contract stored at the decentralized ledger by providing the identifier associated with the first transaction.

7. The method of claim 1, wherein obtaining the remittance information comprises:
requesting the remittance information from a storage service by providing the identifier associated with the first transaction.

8. The method of claim 7, wherein the remittance information comprises the identifier associated with the first transaction, the identifier comprising a combination of a transaction identifier, a sender identifier, and a receiver identifier associated with the first transaction, and wherein the first transaction is signed with a private key corresponding to the sender identifier, wherein the remittance information is obtained based on validating a signed request based on matching receiver identifier in the identifier associated with the first transaction and the received identifier in the remittance information.

9. The method of claim 1, wherein the remittance information comprises at least one payment reference associated with the first transaction.

10. The method of claim 1, wherein providing the remittance information comprises:
processing the transaction information to identify payment requirements associated with the payee;
determining a type of digital assets to be used for performing a payment to the payee based on the identified payment requirements; and
instructing the transfer based on an amount of the type of digital assets to an institution.

11. The method of claim 10, wherein the type of digital assets determined to be used for performing the payment is a first type, and a type of digital assets in the payee account to be used for the transfer being a second type, and wherein instructing the transfer comprises:
converting a first amount of first digital assets of the second type of the payee account into a second amount of second digital assets of the first type.

12. A non-transitory computer-readable storage medium coupled to one or more processors and having instructions stored thereon which, when executed by the one or more processors, cause the one or more processors to perform operations comprising:
obtaining transaction information for a first transaction executed by a payer at a decentralized ledger to transfer of digital assets from a payer account to a payee account of a payee, wherein the transaction information comprises an identifier associated with the first transaction;
obtaining, based on the identifier associated with the first transaction, remittance information associated with the first transaction; and
providing the remittance information to the payee account of the payee as part of providing a transfer of the digital assets to the payee.

13. The non-transitory computer-readable storage medium of claim 12, wherein the remittance information is associated with the first transaction using the identifier derived from at least one transaction attribute of the first transaction.

14. The non-transitory computer-readable storage medium of claim 13, wherein obtaining the remittance information comprises decrypting the remittance information according to an agreed upon protocol for encryption.

15. The non-transitory computer-readable storage medium of claim 14, wherein the remittance information is generated by the payer in an optimized format for the decentralized ledger and stored at the decentralized ledger by creating a smart contract published on the decentralized ledger as associated with the first transaction.

16. The non-transitory computer-readable storage medium of claim 13, wherein the at least one attribute comprises one or more of: a transaction identifier, a sender identifier, a receiver identifier, a timestamp, or a transaction amount.

17. The non-transitory computer-readable storage medium of claim 12, wherein obtaining the remittance information comprises:
invoking a smart contract stored at the decentralized ledger by providing the identifier associated with the first transaction.

18. The non-transitory computer-readable storage medium of claim 12, wherein obtaining the remittance information comprises:
requesting the remittance information from a storage service by providing the identifier associated with the first transaction.

19. The non-transitory computer-readable storage medium of claim 18, wherein the remittance information comprises the identifier associated with the first transaction, the identifier comprising a combination of a transaction identifier, a sender identifier, and a receiver identifier associated with the first transaction, and wherein the first transaction is signed with a private key corresponding to the sender identifier, wherein the remittance information is obtained based on validating a signed request based on matching receiver identifier in the identifier associated with the first transaction and the received identifier in the remittance information.

20. A system, comprising:
a computing device; and
a computer-readable storage device coupled to the computing device and having instructions stored thereon which, when executed by the computing device, cause the computing device to perform operations comprising:
obtaining transaction information for a first transaction executed by a payer at a decentralized ledger to transfer of digital assets from a payer account to a payee account of a payee, wherein the transaction information comprises an identifier associated with the first transaction;
obtaining, based on the identifier associated with the first transaction, remittance information associated with the first transaction; and
providing the remittance information to the payee account of the payee as part of providing a transfer of the digital assets to the payee.
